(19) United States
(12) Patent Application Publication
(10) Pub. No.: US 2009/0143985 A1
(43) Pub. Date: Jun. 4, 2009

(54) SYSTEM AND METHOD FOR MAINTAINING THE RELATIVE DISTANCE BETWEEN TWO VEHICLES

(76) Inventors: Frank K. Weigand, La Canada, CA (US); Aiden J. Bradley, Westlake Village, CA (US); Jeff Anderson, Saugus, CA (US); Gabriel T. Manville, Santa Rosa, CA (US); Paul Yarin, Los Angeles, CA (US); Eric Metois, Arlington, MA (US); Greg Rude, Manhattan Beach, CA (US)

Correspondence Address: K&L Gates LLP, P.O. BOX 1135, CHICAGO, IL, 60690, US

(21) Appl. No.: 11/949,549

(22) Filed: Dec. 3, 2007

(51) Int. Cl. G05D 3/00; B63H 25/52

(52) U.S. Cl. 701/300; 701/41

(57) ABSTRACT

A system that includes a first self propelled steerable vehicle having a first end and a second end, a second self propelled steerable vehicle having a first end and a second end and an electronic device that maintains a relative position between at least one of the first end and the second end of the first self propelled steerable vehicle and at least one of the first end and the second end of the second self propelled steerable vehicle.

### BACKGROUND

The prior art is generally directed to transporting a load, building or house by a flat bed delivery device, such as a truck or other device. Additionally, when transporting a building or house, the prior art delivery devices generally attempt to locate the buildings or houses onto or adjacent a foundation or other structure prior to the building or house being unloaded from the transporter. Locating the house in this manner is generally an attempt to simplify the adjustments necessary to properly position the house upon a foundation.

### SUMMARY

The present invention relates to a system that includes a first self propelled steerable vehicle having a first end and a second end, a second self propelled steerable vehicle having a first end and a second end and an electronic device that maintains a relative position between at least one of the first end and the second end of the first self propelled steerable vehicle and at least one of the first end and the second end of the second self propelled steerable vehicle.

The invention also relates to a method including the steps of sending signal between at least one of a first end and a second end of a first self propelled steerable vehicle and at least one of a first end and a second end of a second self propelled steerable vehicle, determining the relative position of the at least one of the first end and the second end of the first self propelled steerable vehicle and the at least one of the first end and the second end of the second self propelled steerable vehicle, and maintaining the relative position to a predetermined range.

The invention also relates to a vehicle, including a first self propelled steerable vehicle having a first end and a second end and a first electrical system configured to be able to control the velocity of the first self propelled steerable vehicle, a second self propelled steerable vehicle having a first end and a second end and a second electrical system configured to be able to control the velocity of the second self propelled steerable vehicle and a measuring device able to calculate a relative position between at least one of the first end and the second end of the first self propelled steerable vehicle and at least one of the first end and the second end of the second self propelled steerable vehicle and capable of sending the relative position to at least one of the first and second electrical systems to thereby adjust the velocity of at least one of the first and second self propelled steerable vehicle.

Additional features and advantages are described herein, and will be apparent from, the following Detailed Description and the figures.

### BRIEF DESCRIPTION OF THE FIGURES

FIG. 1 is a top perspective view of a transport vehicle according to one embodiment of the present invention;

FIG. 2 is a top view of the transport vehicle shown in FIG. 1;

FIG. 3 is a side elevational view of the transport vehicle shown in FIG. 2;

FIG. 4 is a top perspective view of the transport vehicle of FIG. 1 carrying a load and with one of the load bearing structures removed;

FIG. 5 is a partial side view of one of the load bearing structures shown in FIG. 4;

FIG. 6 is an enlarged view the lifting mechanism and the drive mechanism located at one end of load bearing structures shown in FIG. 5;

FIG. 7 is a top perspective view in section of an axle of one of the bogies for the vehicle shown in FIG. 6;

FIG. 8 is a schematic view of a system configured to drive and steer the bogies of the vehicle shown in FIG. 1;

FIG. 9 is a top perspective view in section of the gripping device for the tensioning system for the transport vehicle

FIG. 10 is an enlarged view of the tendon located adjacent the load for the tensioning system for the transport vehicle;

FIG. 12 is an enlarged view of another embodiment showing the tendon located adjacent the load of the tensioning system for the transport vehicle;

FIG. 13 is a schematic view of the tensioning system for the transport system;

FIG. 14 is a schematic view of a system configured to maintain a load in a substantial planar and substantial level orientation according to one embodiment of the present invention;

FIG. 15 is a schematic top view representation of the vehicle of FIG. 1 in transition from cruise mode to pull in mode showing the vehicle orienting the building for pulling into the predetermined site;

FIG. 16; is a schematic top view representation of the vehicle of FIG. 1 pulling into the predetermined site;

FIG. 17 is a schematic top view representation of the vehicle of FIG. 16 positioning the building over an existing foundation;

FIG. 18 is a schematic side view representation of the vehicle of FIG. 17; and

FIG. 19 is a schematic side view representation of the vehicle of 18 lowering the building onto the existing foundation.

### DETAILED DESCRIPTION

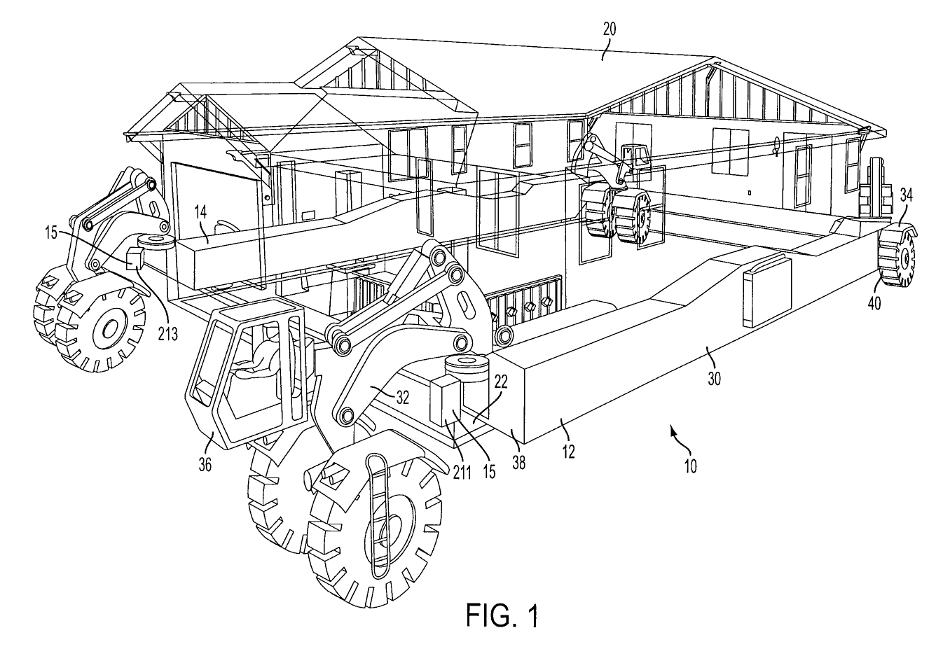

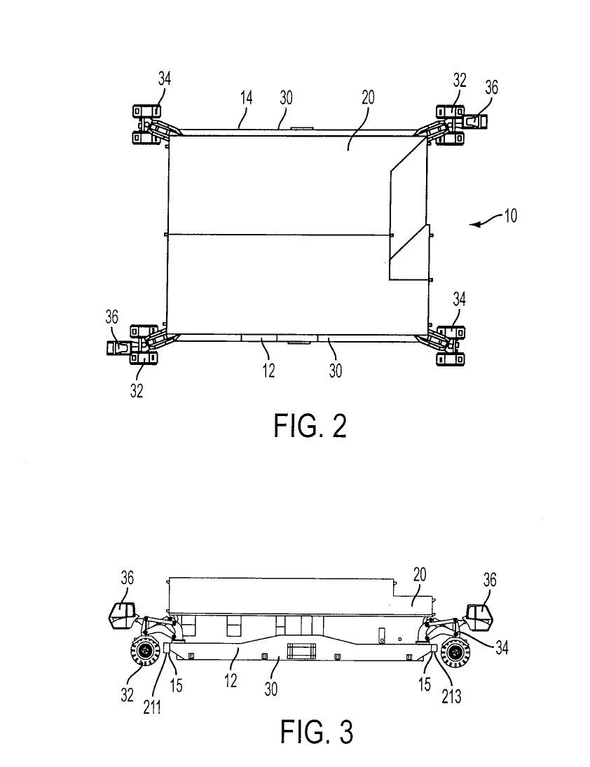

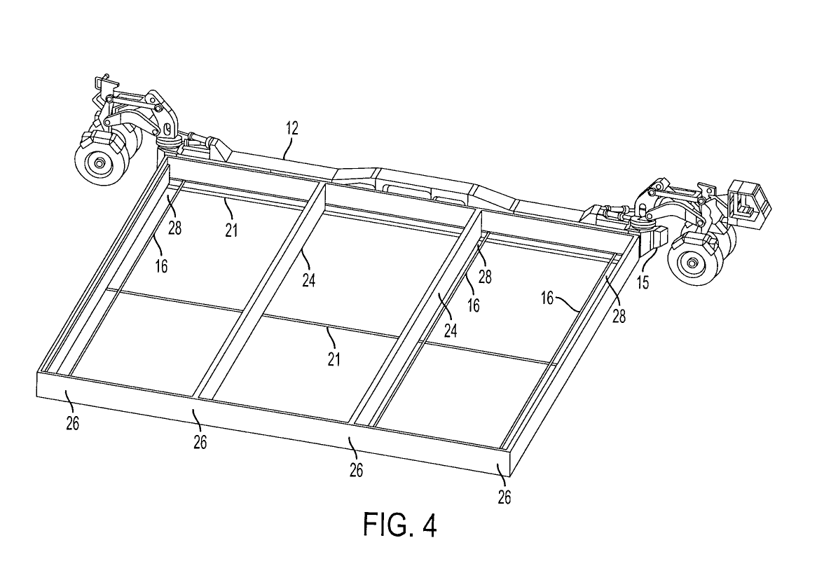

FIGS. 1-4 illustrate a load transport vehicle 10. The transport vehicle 10 includes a first vehicle, load bearing structure or portion 12 and a second vehicle, load bearing structure or portion 14. The first and second portion 12 and 14 can be coupled together using a plurality of metal bands or tendons 16. The relative distance and/or position of the first vehicle 12 and the second vehicle 14 when moving a load 20 can be maintained at a substantially constant or constant distance or predetermined position using an electronic means 15.

Load 20 can be any suitable load to be moved. For example, the load can be a building, a truck container, a box, a carton, a pallet or any other suitable load or combination of loads. Building is defined as any completed, substantially completed or partially completed structure capable of permanent, semi-permanent or temporary occupancy or a house or other large rigid or semi-rigid payload. For example, a house can be a full sized custom home too large to be transported on public roads, a double wide or triple wide mobile home or any other structure desired. When configured as a building or substantially completed house, the load can have a foundation 22 coupled to the building, such that the building can be positioned in any suitable place that can accommodate such a foundation.

When a foundation is used, the foundation can have structures or beams 24 that help the foundation withstand a lateral force, such that the load 20 can be lifted using the compression/tension system and method described herein. The foundation can have a perimeter 23 that is formed in any shape desired. Both the perimeter 23 and beams 24 can be formed from concrete, metal, wood or any other suitable material or combination of materials. Furthermore, the perimeter and beams can include rebar and be integral or separate from each other. When separate, the beams can couple to the perimeter in any suitable manner, including friction or in any other temporary, permanent or semi-permanent manner. It is noted that the load does not need to have beams 24, and can have any suitable device or structure that would help the load withstand the necessary compression.

The load 20 can also have three (or any suitable number of) fixtures 21 running lengthwise and/or widthwise and/or in any suitable direction that support the tendons and accurately locate them relative to one another. These fixtures are built into the foundation and stay with it until the vehicle picks up the load. At that point, if desired, the fixtures can be removed from the foundation and reused. The fixtures can be removed at any other desired time or remain permanently with the foundation. It is also noted that, as stated above, load 20 can be any suitable load and is not necessarily a building, a house and/or a house with a preattached foundation.

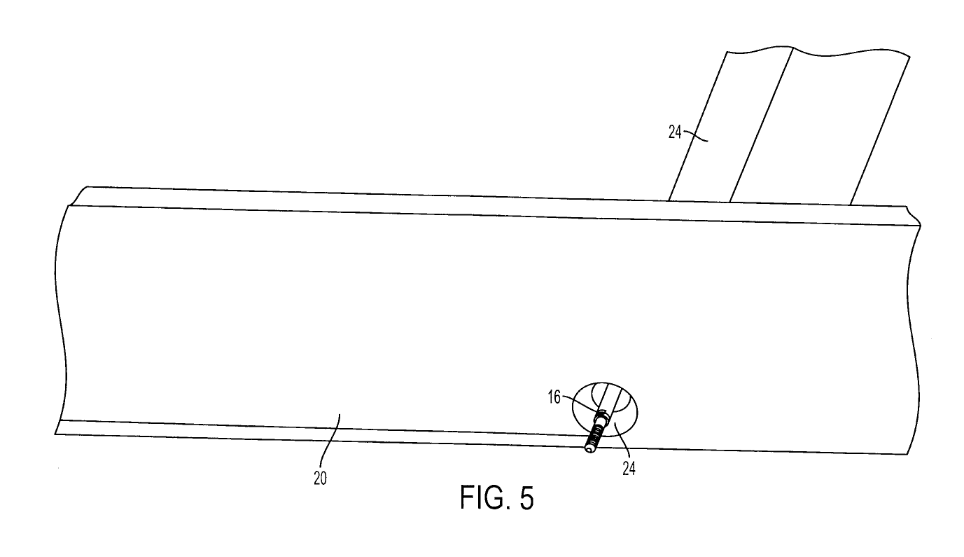

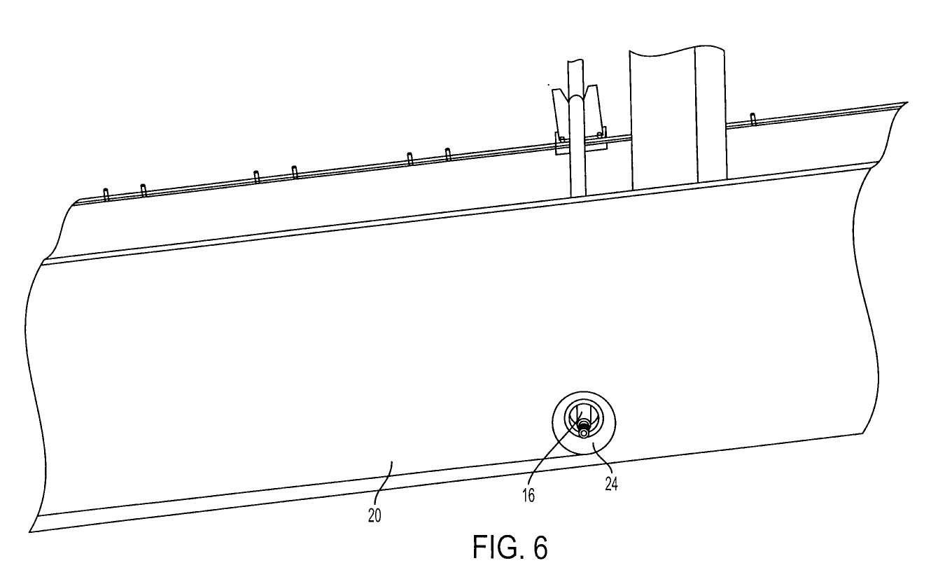

As shown in FIGS. 5 and 6, load 20 preferable has openings or areas 24 that extend through a portion thereof. In this particular embodiment, the openings 24 pass through the foundation; however the openings can pass through any portion of the load or merely pass adjacent the load and not through the load.

As shown in FIGS. 5 and 6, bands 16 are preferably metal tubes that can be any suitable length and/or diameter. For example, the band can extend the entire width of the load, plus several feet beyond the load for gripping purposes or each band can be divided into multiple connectable segments (e.g., 10 foot segments), thus allowing easier retraction in confined areas. There are preferably about four (4) bands, and each of the bands has a first end 26 and a second end 28; however, any number of suitable bands can be used. For example, one band or any number of a plurality of bands can be used. The bands 16 can be formed from any suitable material. For example, bars made by DYWIDAG can be suitable or other suitable high strength bars. Furthermore, bands 16 can be configured in any suitable shape or configuration and they can be hollow, partially hollow, solid or substantially solid or any variation or combination thereof or in any suitable or desirable manner. The bands may pass through any portion of the load. For example, as shown in FIG. 5, the band 16 extends or passes through the structure 24 or as shown in FIG. 6, the band merely pass though the outer perimeter of the load and then through the interior open space thereof. However, the bands can pass through any suitable portion of the load or merely adjacent or near the load, if desired.

As shown in the FIGS. 1-4, the vehicle is formed from two separate vehicles 12 and 14 that connect or couple with load 20 to form a vehicle mover. Preferably, the first and second vehicles or portions 12 and 14 are substantially similar and can either operate alone or in combination. Therefore, the description of vehicle 12 is applicable to both vehicles 12 and 14; however, the vehicles can each be designed in any suitable manner and do not necessarily need to be substantially similar.

As shown in FIGS. 1-3, each vehicle preferably includes a truss or chassis 30, a first bogie 32, a second bogie 34 and a control station 36. The first bogie is coupled or attached to the chassis by a lifting mechanism or means 35 and the second bogie is coupled or attached to a second lifting mechanism or means. The chassis 30 is preferably manufactured from welded plate sections but can be any suitable design and/or configuration, such as being manufactured from welded tubes. Each chassis is generally about 60 feet long, about 44 inches wide, about 92 inches high and weighs approximately 40,000 pounds, including internal equipment; however the chassis can have any suitable dimensions and/or weight as appropriate for the building or load size and weight. Preferably chassis 30 is designed and configured to provide minimal loaded deflection and cope with torsional load when the bogies are offset.

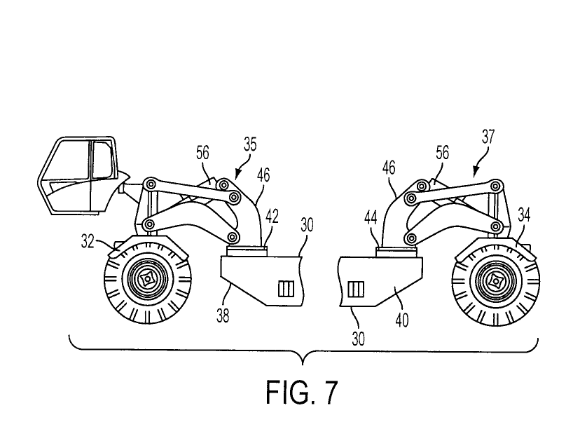

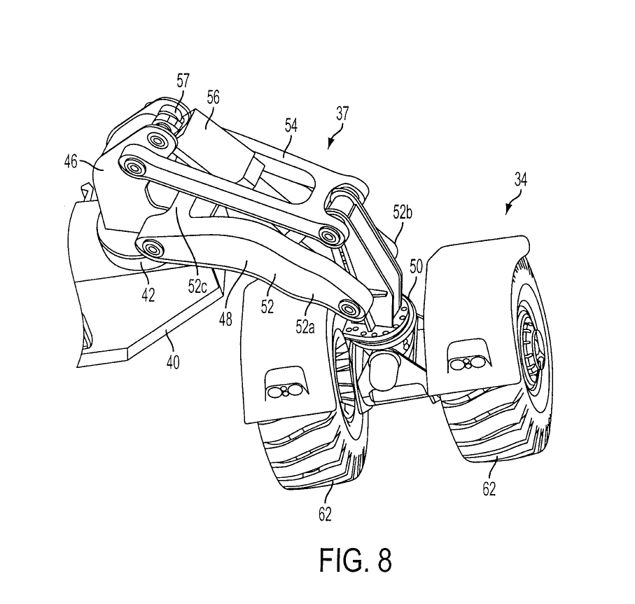

As shown in FIGS. 7 and 8, chassis 30 has a first end 38 and a second end 40, each of which is coupled to a respective lifting mechanism via actively articulated slewing ring bearings 42 and 44, respectively. The ring bearings do not necessarily need to be actively articulated and can be any bearings desired. Furthermore, the chassis can be coupled to the bogies in any suitable manner. Preferably, each lifting mechanism or means can include a protrusion 46, a linkage 48 and an actuator 56; however the lifting mechanism or means can have any suitable structure. Additionally, the structure of the lifting mechanism or means does not need to have the exact structure of the protrusion, linkage and actuator and each of these elements can have any suitable structure. Coupling member or protrusion 46 can extend from the chassis 30, as shown in FIG. 8. A four-bar parallelogram linkage 48 can couple the protrusion 46 on the slewing ring to a rotation pivot 50 on each bogie. The combination of linkage 48 and the ring bearings can allow adjustment of the load. Linkage 48 preferably includes an arcuate or boomerang shaped link 52 having a first portion 52a and a second portion 52b. Portions 52a and 52b are preferably unitarily attached using member 52c, but do not need to be unitary and can be coupled together in any manner desired. Linkage 48 also can include U-shaped linkage 54. Each link is driven by a dedicated hydraulic actuator 56, such that as the actuator extends, the chassis 30 rises relative to the bogie. Preferably one end of the actuator is coupled to protrusion 46 at point 57 and the opposite end is coupled to the rotation pivot 59; however, the actuator can be configured in any suitable manner. The actuator may be either a conventional hydraulic servoactuator, or a counterbalance cylinder concentric and working in parallel with a smaller servoactuator or an electromechanical actuator or any other similar means of actuation. The lifting mechanism can be any suitable mechanism and does not need to include all of the above described elements.

The actuators 56 preferably have a dynamic lifting capacity of at least 200,000 lb each with an 8-inch bore and a 38-inch stroke, but can have any suitable size, configuration and lifting capacity. The bogie travel in the vertical direction is preferably about six feet, but can be any suitable distance. In particular, the conventional servoactuators can be hydraulic actuators with integral position feedback and pressure transducers for load feedback that lift and support the payload.

In another embodiment, counterbalanced actuators can be utilized, which are smaller hydraulic actuators connected to a constant pressure source to lift and support a significant portion of the payload weight. That is, the large conventional servo actuators could be replaced by a smaller counterbalance actuator with a smaller servo actuator mechanically connected in parallel. The counterbalance actuator will support most of the payload's dead weight with the smaller servo actuator only required to actively position the payload

The slewing ring bearing has a range of plus or minus 40 degrees where zero is straight ahead (or any suitable degree) of angular motion. The slewing ring bearing preferably enables the wheel track of a specific vehicle to vary about 15 feet from the nominal load width or it can vary from about 40 feet to about 55 feet, but the wheel track can vary in any suitable amount.

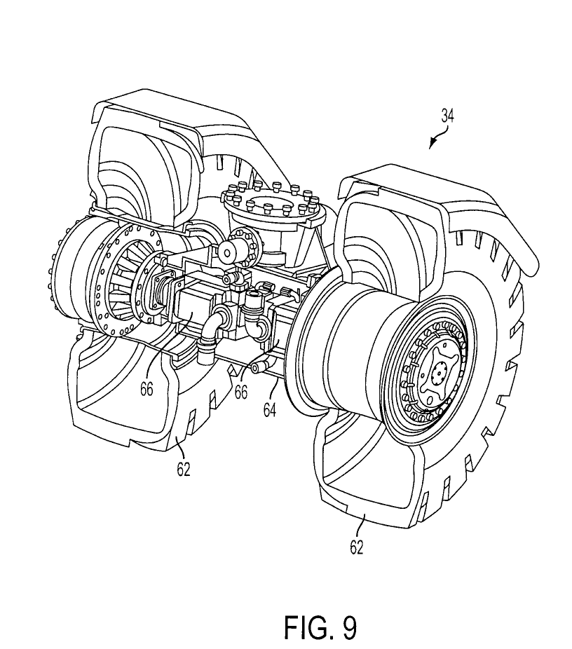

As shown in FIG. 9, each bogie preferably has two wheels 62, but can have any number of suitable wheels. For example, each bogie can have eight wheels, four wheels or any number of wheels that would allow vehicle 12 to operate independently of vehicle 14.

Preferably each independent vehicle has a first bogie 32 and a second bogie 34 and therefore when combined, the transport vehicle has four bogies, one at each corner; but it is noted that each independent vehicle can have any number of suitable bogies. Preferably, each bogie wheel 62 is a driven wheel; but the bogie can have any number of suitably driven wheels (e.g., each bogie can have 1, 3, 4 or more driven wheels). Wheels 62 are on an axle 64 with each wheel being driven by a separate hydraulic motor 66, but they can be driven in any suitable manner. The transport vehicle velocity (longitudinal speed and lateral speed of a reference point on the vehicle) and yaw rate can be controlled by independently controlling the rotational speeds of each wheel. The individual wheel speeds can be precisely controlled to work in concert. By commanding different wheel rotational speeds to the left and right sides of a bogie (called differential steering), each bogie can be made to steer in manner consistent with the velocity and yaw rate of the vehicle as a whole.

As shown in FIG. 1, one end of each independent vehicle has a driver's cabin 36 situated over the bogie and is configured to rotate in any suitable manner. For example, each cabin can rotate up to and including 180 degrees (or any other suitable amount) or, alternatively, the driver and his seat can rotate relative to the cabin. Preferably, the driver's cabin is situated to be a high visibility air conditioned station that allows the driver to control the independent vehicle; however, the driver's cabin can be any suitable steering platform and can be positioned in any suitable area of the vehicle. Additionally, it is not necessary for each vehicle 12 and 14 to have a driver's cabin or steering ability and only one of the vehicles can be equipped with such capabilities or the vehicle can have no on board driver and be remote controlled (wired or wirelessly), controlled via artificial intelligence or computer, run on a track or follow a preprogrammed course or by any other suitable means.

When equipped with two on board drivers, preferably the system operates in a master/slave mode, where one operator is selected as the master. The master is then in control of the vehicle, while the slave can have emergency/motion stop capability. If desired, the system can be configured to allow the operators to switch control of the vehicle (i.e., switch which vehicle is the master and which vehicle is the slave) during transport or positioning of the building or at any other time.

In another embodiment, when using two operators, one in each cab, preferably control the vehicle's motion while communicating to each other over headsets; however it is not necessary for the operators to communicate in the manner, to communicate at all or for there even to be two operators; however the vehicle can be operated in any suitable manner. The vehicle can operate with any suitable number of operators and/or the operators can be positioned remotely from the vehicle and communicate with the vehicle from wired or wireless means or the vehicles can be computer controlled or automated. From each of the operators' points of view, each feels as if they are driving their own corner of the vehicle via a steering wheel or joystick on the console (not shown) or using other suitable device(s). The onboard computer system achieves such operation by generating steering and speed commands for all four bogies based on the input of the two joysticks. In this way, the operators can navigate fairly tight corners. The overall velocity and direction is governed primarily by the master (front) operator. Both operators can maintain pressure on a dead-man enable switch (not shown) to enable motion, if desired.

In each mode of operation, the desired velocity vector can be calculated at each moment based on inputs from the operators and the control or computer control system. Each vehicle 12 and 14 can have a computer control that controls each vehicle when operating individually. In other words, when the vehicles are not engaged with each other, each operator is capable of individually steering a respective vehicle using the input controls and the computer control system. However, each control system is designed and configured to electrically couple or interface with the other computer control system, and thereby control the overall direction and speed of the vehicle 10. One system is designated as the dominate or the master system, either automatically or manually. The computer control system can include an onboard guidance and navigation systems. A Global Positioning System (GPS) can be used to facilitate calculation of the vehicle position in relation to the instant center, if desired. Additionally, the vehicle can use differential GPS with two or more receivers (preferably at least one on each transport vehicle 12 and 14) and a laser-based beacon detector for more precise handling and control; however, it is noted that one GPS, multiple GPSs and/or a laser-based beacon detector can be each be used alone or in combination with each other or not at all, if desired. Furthermore, the vehicle 10 and each individual vehicle 12 and 14 can be controlled and/or steered and/or directed in any suitable manner.

As noted above, differential steering can be used to advance and rotate the vehicle as required. To minimize stresses on the vehicle and payload, algorithms can be used to ensure the bogies steer in a kinematically consistent manner to avoid “fighting” one another. The preferred algorithm, called “countersteering”, transforms operator inputs from any two devices (steering wheel, throttle, joysticks) into 3 vehicle overall commands: longitudinal speed of a reference point on the vehicle, lateral speed of the same reference point on the vehicle, and vehicle yaw rate. The countersteering algorithm transforms the 2 operator inputs into 3 overall commands using an “instant center” calculation. The instant center may be on a line passing through the rear bogies (front wheel steer), on a line passing laterally through the midpoint of the vehicle (“four wheel steering”) or, more generally, on a lateral line located anywhere fore or aft of the center of the vehicle. However, it is noted that it is not necessary to steer the vehicle 10 in this manner and the vehicle can be merely steered by the operator or operators or computer control or other suitable means.

Preferably, the vehicle 10 has two speed ranges available to the master operator through a selection lever in the main cab: “Low” and “High”. Low speed is less restricted with respect to steering and maneuvering, but more restricted with regard to speed. While Low is selected, the steering limit hard stops are retracted allowing full steering range. The hard stops limit the articulation of the bogies. In High range or restricted movement mode, the full range of speeds is available to the operator, but the steering hard stops are engaged. This is a safety feature to guard against a failure of a propulsion motor when traveling at an elevated speed causing the bogie to spin too far resulting in damage to the vehicle or the load. However, the restricted movement mode can restrict the movement or any portion or system in of vehicle 10 in any suitable manner. It is noted that having two speed ranges is merely a preferred embodiment and the vehicle can have any number of speed ranges desired, including one or more than two.

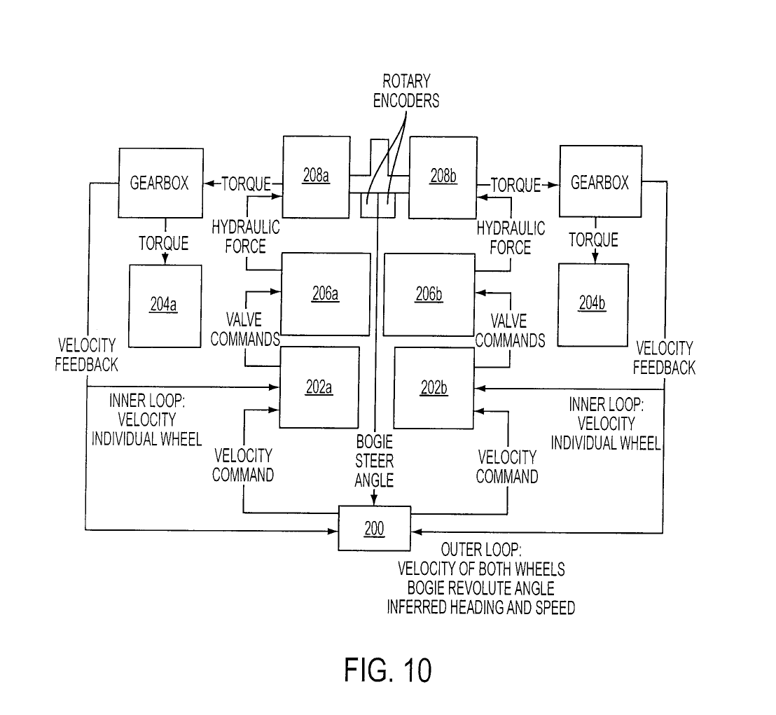

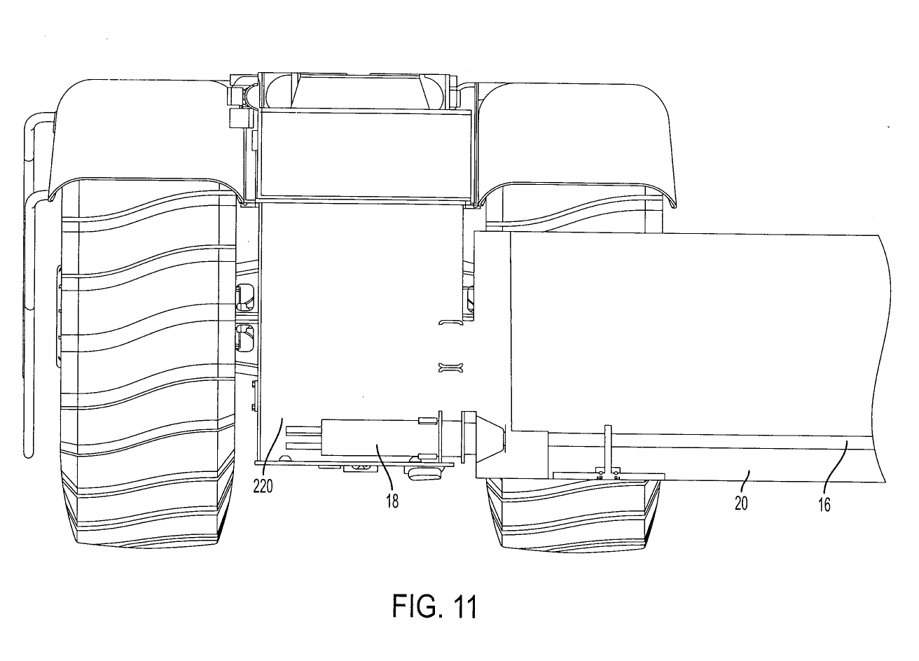

FIG. 10 illustrates an embodiment of the drive system. Vehicle controller 200 is the computer control system that receives data from the operators, GPS receivers and/or the Laser-based beacons or from any other suitable device. The vehicle command is then sent to a controller card 202a and 202b for specific wheel and tire 204a and 204b. Each controller card then sends valve commands to a respective proportional valve 206a and 206b, which in turn sends a hydraulic flow to a respective hydraulic motor 208a and 208b. The hydraulic motors apply torque to a respective gearbox 210a and 210b, which rotate wheels 204a and 204b, respectively. Each motor also transmits velocity and direction feedback data to the vehicle controller 200 and to a respective controller card. For example, the data sent to the vehicle controller can include the velocity and direction of the wheels, the bogie revolution angle and the inferred heading and speed, while the data sent to each controller card can include the velocity and direction of an individual wheel. The data sent to the controller cards and the controller can be any data desired and does not need to include or be limited to this exemplary data. Additionally, this steering system is merely an embodiment and does not limit this invention.

When moving a load, the load 20 is generally the only rigid connection between vehicles 12 and 14; however it is noted that any additional rigid, semi-rigid or any other type of connection can be used. Therefore, the load 20 may be of such that it could be damaged if subject to two opposite, lateral forces. To reduce or eliminate stress on the load an electronic means or measuring device 15 can be used to determine and maintain the relative distance and or position between the vehicles as shown in FIGS. 1-4. Electronic means 15 can be any device suitable. For example, electronic means can be a signal, visual light, laser light, infrared light or any wired or wireless means capable of determining relative distance. The electronic means can be in electronic communication with electrical circuitry, which can include a processor. Through the electrical circuitry, the electronic means can also be configured to control the speed on one or both vehicles 12 and 14.

The electronic means can be configured to maintain the first end of the first self propelled steerable vehicle in such a relative position with the second end of the second self propelled steerable vehicle that an angle between a line drawn between the first self propelled steerable vehicle and the second self propelled steerable vehicle and a perpendicular line drawn between the first self propelled steerable vehicle and the second self propelled steerable vehicle does not exceed about 6 degrees.

In one embodiment, visual light, infrared light or any other suitable light is projected from device 211 and bounced or reflected off device or mirror 213. The reflected light is then captured by the device 211 or an additional device. A processor then compares to the original position of light projected to the captured position. The compared data is then communicated (wired or wirelessly) to the computer control system, which then adjust the velocity and/or position of the vehicles 12 and 14. For example, the velocity and position of only vehicle 12 or only vehicle 14 can be adjusted or the velocity and position of both vehicles can be adjusted or any variation and/or combination thereof.

The electronic means can be located at any position on the vehicles. That is, the electronic means can be positioned at the first end, the second end or at any position in between. Furthermore, there can be multiple electronic means located on each vehicle. For example, since the first end of vehicle 12 is generally aligned with the second end of vehicle 14, the first end of each vehicle can have a projection device located thereon and the second end of each vehicle can have a reception device or mirror 213 located therein. Each device on each vehicle can be in electrical communication with the electrical circuitry and/or a processor on a respective vehicle or on both vehicles. The multiple positions can be averaged by the computer control system or some of the positioning data can be disregarded or any other suitable combination of positioning data can be used.

Fine positioning of each independent vehicle preferably can occur under the control of an operator in the cab and/or one at a remote pendant that can be positioned in any suitable manner, such as outside of the cab or remote from the cab. One independent vehicle is positioned such that its cab is at the back of the building and the other such that its cab is at the front or in any other suitable manner.

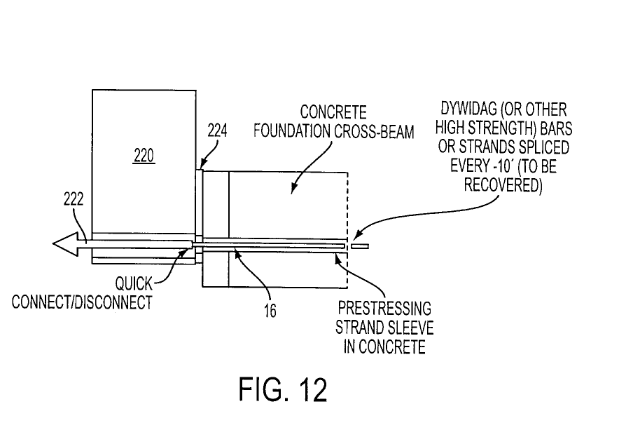

As shown in FIGS. 11 and 12, once the two independent vehicles 12 and 14 are located adjacent the load 20, the tensioning means is activated, such that the load can be lifted. The tension means includes at least one tensioning device 18, which couples to at least one band 16. Bands 16 are coupled to the tensioning devices by inserting the first and second ends of bands 16 into a respective tensioning device 18. If desired, each of the first and second vehicles 12 and 14 can include at least one camera adjacent the bands 16 to facilitate coupling to the bands to the vehicles 12 and 14. If necessary, the bands can bend to take up vertical and longitudinal misalignment. Tensioning device 18 can be a hydraulic actuator or any other suitable device. Preferably, there are eight (8) tensioning devices (one to couple with each end of a band); however, there can be any suitable number of tensioning devices. Tensioning device 18 can be mounted on an outside face of a box beam 220 in the chassis 30. Holes can then be formed in the chassis 30 to allow bands to extend therethrough and into the tensioning device.

The tensioning devices are then actuated pulling bands 16 in the direction of arrow 222. The tensioning devices draw the chassis toward the load and compress the load between the chassis. Each chassis can have a high friction interface 224. The high friction interface can extend along the entire, substantially the entire or any portion of the chassis facing the load. For example the high friction interface can be a series of pads positioned along the chassis. Each of the tensioning devices each can produce about 150,000 pounds of tension; however the tensioning devices can provide any suitable amount of tension.

The tension created by the tensioning devices creates significant compression between the load and the two chassis (or the friction interface). This compression/friction allows the lifting mechanisms to lift and move the load. Once a sufficient compression force is created, the hydraulic actuator 56 on each lifting mechanism is activated, thus lifting the load from the ground.

Additionally, two inter-connect cables between the two independent vehicles can be connected, one at the front of the building or load and one at the back, so that the vehicles can operate as one unit in the master-slave arrangement. Once in this configuration, the load can be lifted by the vehicle. However, it is noted that the vehicles can couple in any suitable manner (e.g., wirelessly) and/or at any suitable time and do not necessarily need to be electrically coupled in this manner (or at all) or approach and position themselves in this manner.

With the load loaded, as stated above, one independent vehicle can be selected as the master and the other as the slave using a selection switch on each console or any in other suitable manner. While operating in “cruise mode”, the cab at the front is typically the master and the one at the rear is the slave; however, the vehicle can be operated in any suitable manner. When entering “cruise mode”, an onboard computer system can confirm that the two inter-connect cables are attached and that one cab is set as master and one is set as slave. The onboard computer system can also confirm that all load sensors are within nominal range and that the load is level and/or planar within tolerance as well as other suitable tests as may be required to verify that it is safe to change modes. At this point, the master cab operator can begin moving the vehicle.

While transporting the load to a particular or predetermined site, the bogies are preferably set so that the shortest face of the load is facing forward (i.e., transverse to each chassis, as shown in FIG. 1) and the bogies are set at their narrowest position. That is, the bogies can be “tucked in” to their narrow most position, so that the wheels can run on the roadways or traverse other possibly narrow areas in route to the predetermined site. However, it is noted that the bogies can operate in any position desired or suitable during any of the steps of transporting or positioning the building or load.

As vehicle 10 pulls away, all four bogies can be folded in to their fully retracted position. Such positioning would allow the overall wheel track to be narrow enough to pass through potentially narrow areas; however, the bogies can be positioned in any desired configuration. Folding to this position can be achieved by means of a switch on the console or by any other suitable means. At this point, as the vehicle drives forward, the slewing ring bearings can fold in automatically. However, as noted above, the bogies can be positioned in any desired or suitable position at any time during loading, setting or transporting the building or load 20.

Preferably, the load is maintained in a substantially planar and/or substantially level position throughout its conveyance to a predetermined position or location. Sensors or other suitable means monitor the angle of the load with respect to a gravity vector while other sensors or means measure the pitch angle induced on the bogies due to the slope of the ground. Based on this input, the onboard computer system causes the servoactuators 56 at each bogie to adjust accordingly to maintain planarity and level. In all modes, this planarity and leveling action should supersede the travel velocity in so far as the onboard computer system will automatically slow down the wheels to accommodate the leveling response time as necessary. If the system should ever reach the threshold where proper planarity and leveling cannot be maintained, the onboard computer system can command a reduced speed, or, if necessary, invoke an Automatic Stop, bringing forward travel to a halt at a suitable speed or deceleration.

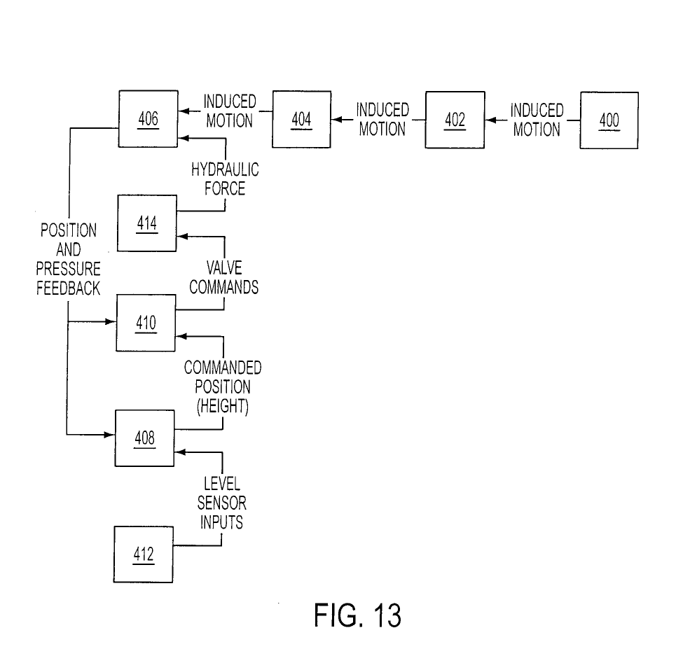

FIG. 13 is a schematic representation of the onboard self-leveling system. This system allows a load or building to be transported from one site (such as the manufacturing or building site) to a second site (such as the graded lot or final position for the building).

When traversing a road surface 400 the roughness or other unevenness of the road can and generally does induce motion through the tire and lift 402, the actuator linkage 404, and actuator 106. Preferably information from each bogie and/or servoactuator 56 is sent to the vehicle controller 408. That is, the leveling system preferably receives data from sensors on each of the four hydraulic cylinders located on each bogie (for example, bogies 32 and 34 and actuator 56); however, the system can receive input from any number of suitable hydraulic actuator sensors or other means. The sensors on the actuators then send signals identifying their position and pressure feedback to both the controller card 410 and the vehicle controller 408. Additionally, at substantially the same time or on a continual basis, leveling sensors and/or planarity sensors (e.g., strain gages attached to the load floor structure or laser alignment devices) 412 send a signal to the vehicle controller. Preferably the leveling sensors and/or planarity sensors 112 send signals at specific intervals; however, the sensors can send signals on any desired schedule. The leveling sensors and/or planarity sensors 412 can include one device or any other number of suitable sensors.

The vehicle controller 408 processes the information from the actuator 106 and the leveling sensors and/or planarity sensors 412 and sends a commanded position to the controller card 410. For example, as stated above, the sensors and/or planarity sensors 412 can be any suitable means for monitoring the angle of the load with respect to a gravity vector and/or other means that measure the planarity of the vehicle chassis using at least three points directly under the slewing ring bearings or other suitable locations.

The controller card 410 then using the data or information received from the vehicle controller 408, the sensors 412 and/or the hydraulic cylinder(s) 406 relays or sends valve commands to the proportional valve(s) 414. The valve(s) in turn control the hydraulic cylinder(s) to adjust the height of the building or portion of the building overlying the specific hydraulic cylinder. Such a system enables the vehicle to continually monitor the position of the building and adjust as the vehicle transports the building to a specific site.

While this leveling and or planarity system is preferably used with a transport vehicle that is formed from two separately joined vehicles, this system can be used with any suitable transport vehicle, including a unitarily constructed vehicle or a vehicle formed from any number of other separately joined vehicles.

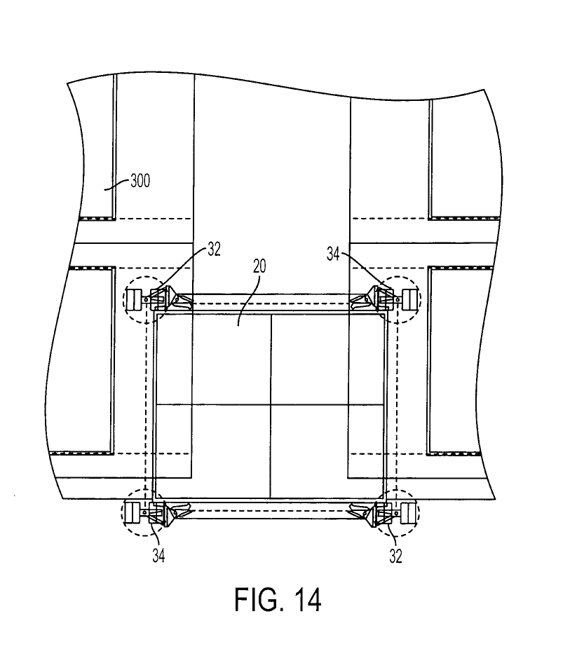

As shown in FIG. 14, the vehicle is brought to the vicinity of the site 300 onto which the building or load will be positioned. Depending on the exact geometry of the final location, the operators can have a specific target range of position and orientation to park the vehicle 10. The onboard display preferably can indicate when the vehicle is within the proper range based on GPS readings by onboard receivers or by any other suitable method or device. However, if desired, the operator(s) can merely manually position (e.g., using visuals) the load at a desired location.

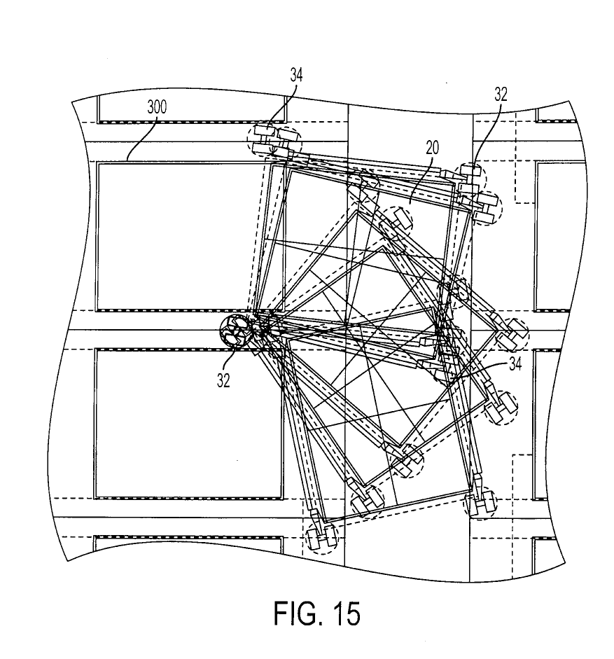

As shown in FIG. 15, the bogies are capable of independently turning and driving, thus allowing for increased maneuverability. This allows the vehicle to essentially pivot about one bogie, thus turning and positioning the load in a crowded environment.

Alternatively, vehicle 10 can transition from cruise mode, where the short side of the load is leading, to “crab mode”, where the long side of the load leads. In crab mode, the wheels are rotated 90 degrees and the slewing ring bearings are arranged to minimize the overall width of the vehicle. This orientation aligns the load with the foundation at the preselected site and sets the transport vehicle for “pull-in mode”. During the pull-in maneuver to position the load at the predetermined site 300, the leading bogies can splay out to clear the obstacles, such as a foundation, if such an obstacle exists.

Additionally, “crab mode” can be implemented as the vehicle approaches the load placement site 300. The vehicle can transition from “cruise mode” configuration to “crab mode” configuration at some point before the vehicle arrives on adjacent the area where the load will be located; for example, the street adjacent a predetermined site. The vehicle then proceeds with the load sideways, i.e., the side of the load is leading. Once the vehicle aligns the load with the predetermined site 300, the bogies rotate 90 degrees; the leading bogies splay outwards.

The advantage using the “crab mode” maneuver prior to arrival at the site 300 is that it does not require that one of the adjacent sites be empty in order to set the load, depending on the specific set-up and/or configuration of the adjacent buildings and/or based on other objects that may be positioned in and around the load site.

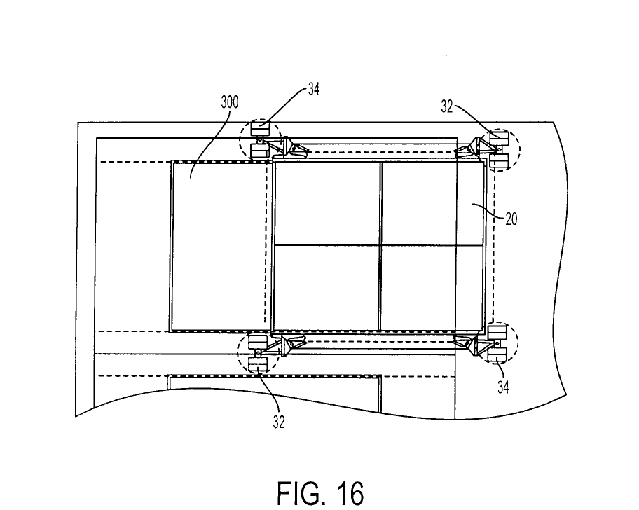

As shown in FIG. 16, if desired, the vehicle can have a pull-in mode. “Pull-in mode” may be necessary when precise final positioning of the load is necessary. “Pull-in mode” can have a laser beacon (not shown) or any other suitable device or method being placed on a survey point at the back of the site or in other suitable position, as a precise reference point.

FIG. 16 is merely a schematic drawing of the bogies and is not a full drawing of each independent vehicle, including the chassis and cabs. This figure is merely for exemplary purposes of the “pull-in mode” and is not meant to limit the structure of the herein described vehicle. When the system is switched into “pull-in mode”, the onboard computer system can check to make sure that the vehicle is within the correct starting range using both the GPS receivers and two sensors receiving the rotating beam from the laser beacon. If all the inputs are consistent, the system can indicate that it is ready to begin the automated procedure of pulling in.

The operator then ensures that the path ahead is clear and initiates motion by means of a pushbutton. The vehicle then begins moving at a “creep speed”, which it will maintain throughout the pull in procedure. The operators can have the capability to slightly adjust the motion by way of their joysticks and both must keep pressure on their respective dead-man enable switches.

The onboard computer system automatically drives the vehicle to a precise location and orientation. As the vehicle automatically maneuvers to the known point, the system splays out the two front yokes as needed to fit outside the foundation. When the vehicle reaches the front of the foundation, it will stop and allow the operators to confirm the location visually. However, it is not necessary to have a precise “pull-in” mode. Such a precise positioning of the load is dependent upon the load and the site. It is possible that the load can be positioned manually by the operators or by a computer control system, thus, be positioned within any desired parameters. For example, the operators can position the load within about a 0-10 foot range or footprint.

Preferably, the splay of the lead bogie occurs during pull-in and the rear outer-most bogie remains in full tuck position; however, each or all of the bogies can be positioned in any suitable position and are not limited to the specific positions described herein.

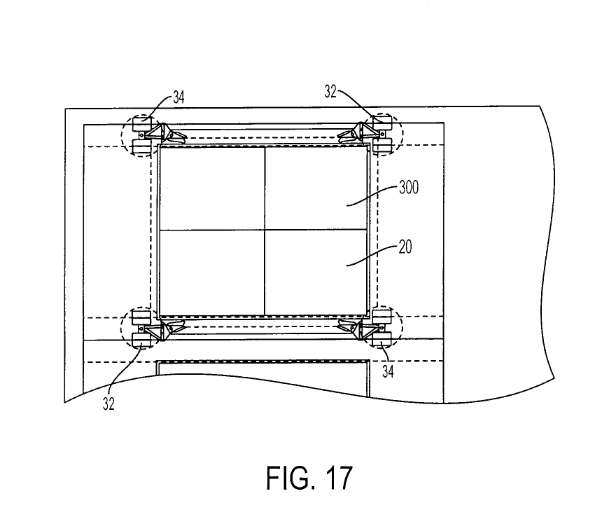

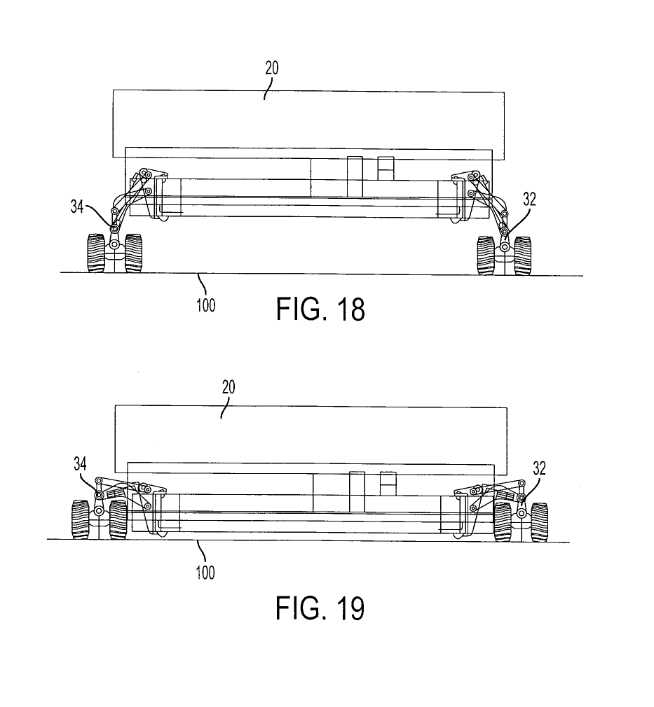

As shown in FIGS. 17-19, once the load is positioned over a predetermined site 300, the load is lowered onto the site. The site can be a graded lot, or a lot having a full, substantially full or partial foundation, merely a dirt or concrete (or other substance) area, or any other suitable final or temporary position for a load.

The four-bar parallelogram linkage 48 and slewing ring structure 42 allow for final positioning of the load over the site 300 in “set mode”. Through coordinated and controlled movement of the slewing ring bearings, combined with controlled movement in a straight line of the bogies along the side edges of the site, the transport device 10 achieves sufficient latitudinal, longitudinal, and rotational movement over a small range to allow the operators to precisely align the load with its site. However, since the load can be placed on a graded site, it is not necessary to have the load placed in a precise manner, and the operators can be given sufficient leeway to place the load within a predetermined area.

The tensioning devices disengage from the bands and each vehicle 12 and 14 is individually driven (manually or automatically) away from the site. The bands can them be removed (or left with the load). If the bands are formed from a plurality of segments, the segments are disconnected and individually removed.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A system, comprising:
a first propelled steerable vehicle having a first end and a second end;
a second propelled steerable vehicle having a first end and a second end; and
an electronic means for maintaining a relative position between at least one of the first end and the second end of the first propelled steerable vehicle and at least one of the first end and the second end of the second propelled steerable vehicle.

2. A system according to claim 1, wherein
the electronic means includes at least one processor in electrical communication with at least one the first propelled steerable vehicle and the second propelled steerable vehicle.

3. A system according to claim 1, wherein
the electronic means includes an infrared sensor.

4. A system according to claim 1, wherein
the electronic means includes a laser.

5. A system according to claim 1, wherein
the electronic means includes visible light.

6. A system according to claim 1, wherein
the first and second propelled steerable vehicles are in electrical communication.

7. A system according to claim 6, wherein
the first and second propelled steerable vehicles are configured to transport a load that can be damaged if subject to two opposite, lateral forces.

8. A system according to claim 7, wherein
the electronic means is configured to maintain the first end of the first propelled steerable vehicle in such a relative position with the second end of the second propelled steerable vehicle that an angle between a line drawn between the first propelled steerable vehicle and the second propelled steerable vehicle and a perpendicular line drawn between the first propelled steerable vehicle and the second propelled steerable vehicle does not exceed about 6 degrees.

9. A method, comprising the steps of
sending signal between at least one of a first end and a second end of a first propelled steerable vehicle and at least one of a first end and a second end of a second propelled steerable vehicle,
determining the relative position of the at least one of the first end and the second end of the first propelled steerable vehicle and the at least one of the first end and the second end of the second propelled steerable vehicle, and
maintaining the relative position to a predetermined range.

10. A method according to claim 9, wherein
the step of maintaining the relative position to a predetermined range includes automatically adjusting the speed of at least one the first propelled steerable vehicle and the second propelled steerable vehicle.

11. A method according to claim 9, wherein
the step of determining the relative position includes using an infrared sensor.

12. A method according to claim 9, wherein
the step of determining the relative position includes using a laser.

13. A method according to claim 9, wherein
the step of determining the relative position includes using visible light.

14. A method according to claim 9, further including the step of
transmitting the relative position to an electrical system that it is electrical communication with both of the first and second propelled steerable vehicles.

15. A method according to claim 9, further including the step of
transporting a load between the first and second propelled steerable vehicles, wherein the load can be damaged if subject to two opposite, lateral forces.

16. A method according to claim 15, wherein
the step of maintaining the relative position includes maintaining the first end of the first propelled steerable vehicle in such a relative position with the second end of the second propelled steerable vehicle that an angle between a line drawn between the first propelled steerable vehicle and the second propelled steerable vehicle and a perpendicular line drawn between the first propelled steerable vehicle and the second propelled steerable vehicle does not exceed about 6 degrees.

17. A vehicle, comprising:
a first propelled steerable vehicle having a first end and a second end and a first electrical system configured to be able to control the velocity of the first propelled steerable vehicle;
a second propelled steerable vehicle having a first end and a second end and a second electrical system configured to be able to control the velocity of the second propelled steerable vehicle; and
a measuring device able to calculate a relative position between at least one of the first end and the second end of the first propelled steerable vehicle and at least one of the first end and the second end of the second propelled steerable vehicle and capable of sending the relative position to at least one of the first and second electrical systems to thereby adjust the velocity of at least one of the first and second propelled steerable vehicle.

18. A vehicle according to claim 17, further comprising
a coupling mechanism configured to couple the first electrical system and the second electrical system and allow electrical communication therebetween.

19. A vehicle according to claim 17, wherein
the first and second propelled steerable vehicles are configured to transport a load that can be damaged if subject to two opposite, lateral forces.

20. A vehicle according to claim 17, wherein
the measuring device is configured to maintain the first end of the first propelled steerable vehicle in such a relative position with the second end of the second propelled steerable vehicle that an angle between a line drawn between the first propelled steerable vehicle and the second propelled steerable vehicle and a perpendicular line drawn between the first propelled steerable vehicle and the second propelled steerable vehicle does not exceed about 6 degrees.
